(19) United States
(12) Patent Application Publication
(10) Pub. No.: US 2010/0146272 A1
(43) Pub. Date: Jun. 10, 2010

(54) METHOD OF CONTROLLING INFORMATION REQUESTS

(76) Inventors: Angelo Centonza, Winchester (DE); Robert Hancock, Southampton (GB); Eleanor Hepworth, Hampshire (GB); Stephen McCann, Southampton (GB)

Correspondence Address: STAAS & HALSEY LLP, SUITE 700, 1201 NEW YORK AVENUE, N.W., WASHINGTON, DC, 20005, US

(21) Appl. No.: 12/450,024

(22) PCT Filed: Feb. 20, 2008
(86) PCT No.: PCT/EP2008/052084

§ 371 Date: Feb. 5, 2010

(30) Foreign Application Priority Data
Mar. 8, 2007 (GB) 0704403.5
Mar. 15, 2007 (GB) 0704996.8
Sep. 17, 2007 (GB) 0718056.5

(51) Int. Cl. G06F 15/16; H04L 9/32

(52) U.S. Cl. 713/168; 709/229

(57) ABSTRACT

A method controls information requests in a system operating in an unauthorised, unassociated mode. The system includes at least one user device and an access point. The method involves receiving at the access point a first information request from a user device and a user device identifier. A utilization indicator is set. At the access point a second information request is received from a user device. A check is performed to determine whether the timer has expired; and if so, processing the second information request for response.

### CROSS REFERENCE TO RELATED APPLICATIONS

This application is based on and hereby claims priority to PCT Application No. PCT/EP2008/052084 filed on Feb. 20, 2008 and GB Application Nos. 0704403.5, 0704996.8 and 0718056.5, respectively filed on Mar. 8, 2007, Mar. 15, 2007 and Sep. 17, 2007, the contents of which are hereby incorporated by reference.

### BACKGROUND OF THE INVENTION

Conventionally, networked communication systems have required a degree of checking and control of a user before permitting the user to access services and resources on the network. This prevents the network from becoming overloaded, requiring excessive use of resources at the access point, or within the network, or consuming bandwidth. However, more recently, some networks have been set up to operate in a state whereby a user device can start transmitting to the network without undergoing any checks, such as an authentication or association process first. Examples of such systems are IEEE 802.11 generic advertisement service (GAS) protocol, or in 2G or 3G cellular communications, for example, universal mobile telecommunications system (UMTS) home base stations, or home node Bs. However, these systems do not address the problem of a terminal sending too many requests to the access point (AP), which in turn would generate a large number of responses that could overload and eventually congest the system. This access point has to process a huge number of requests and in the core network, the server also has to process these requests by looking up in a database and formulating a reply.

The IEEE 802.11u GAS protocol allows an IEEE 802.11u capable terminal in an unauthenticated and un-associated state (state 1) to send requests to an AP and receive responses from it containing information about the network, for example network discovery information, availability of services, or roaming agreements. Generic Advertisement Protocol and GAS Traffic Indication Map (GASTIM) are both current definitions within the IEEE 802.11u draft standard. In UMTS and LTE, a so called home NodeB (HNB) may power on and start communicating with a macro base station in order to determine, for example, the maximum transmission power to use or the frequency bandwidth used by the macro layer. Such communication may occur in an un-authenticated, or un-associated mode. As the number of HNBs within a Public Land Mobile Network is forecast to be in the order of millions, such a process of request/response between the HNBs and the network nodes with which the HNB interacts needs to be controlled.

The above behavior may result from one of several causes, such as a badly behaved user application, on the terminal, or home base station, which is set to generate a large number of requests, or transmissions; or a malicious terminal, or home base station, generating high numbers of requests, which is trying to use all the radio and network resources available, i.e. a denial of service attack.

### SUMMARY

The inventors propose a method of controlling information requests in a system operating in an unauthorized, un-associated mode, the system comprising at least one user device and an access point; comprises receiving at the access point a first information request from a user device and a user device identifier; setting a utilization indicator; receiving at the access point a second information request from a user device; checking to determine whether the timer has expired; and if so, processing the second information request for response.

In order to prevent the number of information requests becoming unmanageable, a utilization indicator is set according to the degree of congestion within the system, so that a user only gets a response to one request made within the set time frame. The utilization indicator may be a base time, a timer, a sequence number, or other indicator allowing the access point to estimate the intensity with which the terminal is accessing resources.

The check of expiry of the utilization indicator may be tied to the identity of the user making the request, but in periods of very high loading, preferably, the check of expiry of the utilization indicator is independent of the identity of the user device making the information request, as indicated by the user device identifier.

In this way, the utilization indicator can set the total number of responses provided within a certain timeframe.

Alternatively, the check of expiry of the utilization indicator is only made if the identity, as indicated by the user device identifier, of the user device making the second information request is the same as that of the user device which made the first information request.

This allows different users to make requests, but restricts the number that are successful for any one user device.

Generally, the need to vary the utilization indicator is greatest when the system becomes overloaded, so preferably, the access point varies the length for which the utilization indicator is set to reduce the number of requests to which responses are provided.

However, this can be reversed when the system is only lightly loaded.

Preferably, the utilization indicator is set according to the number of information requests which can be processed by the access point and a core server.

Preferably, the utilization indicator is sent to the user device making the first information request.

This allows the user device to monitor the utilization indicator and send a second information request after expiry of the utilization indicator.

Preferably, the system is a wireless access network.

The method is particularly important for wireless access networks, as there are greater constraints on resources using the air interface.

Any wireless communication system that operates in a state which does not control the request for resources can benefit from the method, but preferably, the system is one of a wireless local area network and a home base station, such as a UMTS home node B.

The method is particularly applicable when the system is a wireless local area network operating in accordance with the IEEE 802.11 standard.

Preferably, the utilization indicator comprises a timer comprising one of a generic advertisement server traffic indication map period and a generic advertisement server comeback delay.

These timers are already defined within the IEEE 802.11 standard, but as fixed times. The method allows them to vary to take account of current system requirements.

The inventors also propose a second method of controlling information requests in a communication system operating in an unauthenticated, un-associated state, the system comprising at least one user device and an access point comprises sending a first information request from the user device to the access point; at the access point, determining data including at least one of a user device identifier and a utilization indicator; encrypting the data and returning the encrypted data to the user device; receiving a second information request from the user device, including the encrypted data and a current user device identifier; decrypting the data; comparing the decrypted user device identifier with the current user device; and comparing the decrypted utilization indicator with a current utilization indicator; wherein if the or each comparison satisfies certain requirements, responding to the information request from the user device.

This second method addresses the problems caused by rogue terminals making excessive numbers of requests by changing their identity. Instead of dealing with requests as they are received, the access point will only allocate resources for processing the request if the identity is shown to be the same as that of an earlier request. The utilization indicator allows the system to vary the interval between requests and so optimize operation.

If one comparison is positive, a response may be sent, but preferably, only if both comparisons satisfy the requirements, is a response to the information request sent.

Preferably, if both comparisons fail, the access point drops the information request.

The information request may be dropped without any further notification to the user device, but preferably, a notification is sent to the user device if the request has been dropped.

Preferably, the encrypted data is packaged for sending to the user device, for example, the package is a cookie.

Preferably, the utilization indicator comprises a base time, or a base sequence number.

Preferably, the comparison of the utilization indicators comprises determining an elapsed time since the decrypted base time and comparing the elapsed time with a timer

Alternatively, the amount by which the sequence number has changed is used.

If a base time is determined, an unencrypted timer is also sent to the user device with the returned encrypted data.

This allows the user device to determine how long it must wait before making a further information request.

Preferably, the requirements are that the elapsed time is greater than a time set in the timer; and the decrypted user device identifier is the same as the current user device identifier.

Alternatively, the requirements are that the current sequence number is greater than the base sequence number by at least a predetermined amount

Preferably, a notification is sent to a core network if the decrypted identifier is not the same as the current user device identifier.

This allows the core network to warn other access points of the existence of the rogue terminal and take appropriate action.

Preferably, the base time is the time of receipt of the original message at the access point.

Alternatively, it can be a starting point for an elapsed time to be calculated from.

Preferably, the access point is a wireless access point.

A wireless access point has particular problems with overuse of resources over the air interface, which the method addresses.

Preferably, the wireless access point is one of a wireless local area network and a home base station, such as for use with a UMTS based network.

The method is particularly applicable to a wireless local area network operating in accordance with IEEE 802.11 standard.

Preferably, the information request is a generic advertisement protocol request.

Preferably, the user device identifier is a media access control address.

Preferably, the utilization indicator is varied in accordance with the level of congestion in the system.

The inventors further propose, a communication system operating in an unauthenticated, un-associated state comprises at least one user device and an access point, wherein the access point comprises an encryption device to encrypt data received from the user device in a first information request; and a processor to compare data received from the user device in a second information request with the encrypted data; and wherein the user device comprises a store to store the encrypted data received from the access point, for resending with the second information request.

As before, the access point may use a utilization indicator to enable the rate at which further information requests are received and acted upon to be controlled, for example using a timer, a sequence number, or other indicator of rate of accessing of resources.

Preferably, the data comprises a base time for the first information request and the system further comprises a timer in the access point; and a processor to determine whether an elapsed time from the base time is greater than the length of time set by the timer.

Preferably, the user device is one of a wireless local area network terminal and a home base station.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an example of a typical UMTS system for carrying out the proposed method;

FIG. 2 shows an example of a typical WLAN system for carrying out the proposed method;

FIG. 3 illustrates operation of the proposed method in the system of FIG. 1. FIG. 4 illustrates the proposed method for the WLAN system of FIG. 2, using a ‘reply_time’ parameter;

FIG. 5 illustrates an example of a mechanism using a ‘come_back’ or ‘GASTIM period’ parameter, for the WLAN system of FIG. 2; and,

FIG. 6 is a message sequence chart for controlling information requests using encryption for the system of FIG. 2.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

To stop misuse, the inventors propose a method and system that provide thresholds which are set up at the access point for the overall number of requests which can be generated, either or both, irrespective of the sender; or per terminal requesting within a certain time interval, i.e. if the number of requests is within a limit for the terminal, but the terminal is asking too frequently, then both limits may be applied.

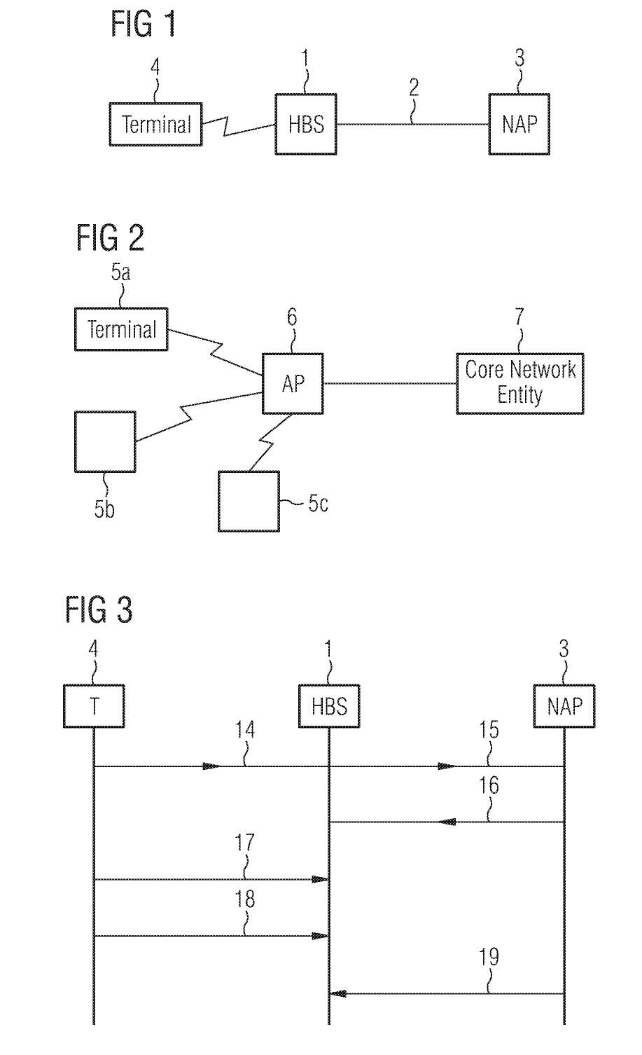

FIG. 1 is an example of a UMTS system using a home base station. The home base station (HBS) 1 connects 2 to a network access point (NAP) 3 via cable, or wireless broadband and provides a wireless connection to a UMTS terminal 4 such as a mobile phone.

FIG. 2 shows an example of an IEEE 802.11 based system in which wireless terminals 5a, 5b, 5c, e.g. a laptop, connect through a wireless access point (AP) 6 and send a GAS request which if processed, may need to be forwarded to a core network entity 7. In 802.11 there are two timers, a GASTIM period, i.e. the number of beacons after which a reply is sent and a GAS comeback delay, which is when the first response says when the final response will arrive, so the terminal can switch off in between.

The method provides flow control of responses depending on the rate of requests received and the timer given back. If conditions for flow control are in place, any request received causes a timer to be sent back. If the next request is within the expiry period, then either the second request is dropped without notification; the second request is queued for response after expiry of the timer; or the second request is dropped and a status code sent back indicating this.

The access point can modify the length of the timer, so that in congested periods, a time window during which a terminal, or home base station, is not able to make a second information request is increased, i.e. the time which the terminal must wait to make a second request, or the time between any two requests. This means that the access point and any server within the network entity can work flat out and generate responses in the minimum time without failing. The result is an optimum service with correct functionality, instead of a system which operates more quickly, but in which one, or both of the servers may fail as a result.

The advantage of the method is that no additional storage is required to optimize the result, just a different way of using an existing mechanism. In 802.11, the two timers or delays have conventionally had a fixed time period, whereas by making these variable according to the conditions, a more efficient service is provided, without system overload and failure.

Specific examples of the method will now be described with reference to UMTS and IEEE 802.11. In the example of a UMTS system, the terminal 4 sends a message 14 via the home base station 1 and the message is forwarded 15 to the network access point (NAP) 3. The NAP returns a timer 16 indicating that it will not accept any further transmissions from the HBS until the timer has expired, so additional calls 17, 18 from terminals to the HBS 1 are either not forwarded to the NAP, or are dropped on receipt at the NAP 3. After expiry of the timer 16, a response 19 is sent from the NAP 3. The delay before the NAP accepts another transmission from the HBS 1 is dependent upon the degree of congestion in the network and is varied accordingly.

For the IEEE 802.11 based system, the main concern is not the number of GAS requests generated by the terminal, but the processing involved, at the AP, for the formulation of the GAS responses. Another issue is the amount of network and radio resources used in state 1 for delivery of a large number of responses back to the terminal. Due to the lack of authentication and association, it is typically very hard for the network and AP to impose any level of control over the terminal, which in many wireless systems means that this sort of behavior has not been allowed. However, due to the nature of the IEEE 802.11 system, this feature must be allowed, so the problems associated with it have to be addressed.

Typically, a GAS request is small in size, usually in the order of a few bytes, whereas a GAS response (commencing at the AP) contains the information provided by a higher layer application (e.g. a network advertisement protocol) as a reply to the initial GAS request sent by the terminal, so this GAS response can be large, up to the order of a few kilobytes. As the terminal may act in any way it wishes, in this state 1, it is not possible to guarantee that the terminal will limit the number of GAS requests sent, so the system relies on the terminal behaving according to recommended guidelines. However, this is not guaranteed.

Therefore, the method limits the rate at which GAS requests are processed by the AP for response formulation and transmission. This is addressed by having a timer which is started whenever a GAS request is received from a terminal with a unique MAC address. While this timer is running, the AP ignores any GAS request sent by the terminal with the same MAC address that triggered the timer to start. Timer expiry triggers the AP to process the GAS request and to eventually provide the response.

There are various possible ways of implementing this. In the example of FIG. 2 and the message exchange shown in FIG. 4, when the AP 6 receives a GAS request 8 from a terminal 5a, identified by its unique MAC address, the AP immediately replies 9 to the terminal with a time, after expiry of which the terminal can send another GAS request, if it so wishes. The AP will forward 10 the initial GAS request to the appropriate network entity 7, from which it receives a response 11, or the AP processes the request internally if the requested data are available. A GAS response 12 is sent to the terminal 5a as soon as it is available, i.e. the terminal might receive a GAS response before the timer expires. If the terminal 5a tries to send a further GAS request before the timer has expired within the AP 6, then the AP will ignore it and block requests from that terminal 5a for a fixed interval of time. Optionally, if the system is particularly close to its loading limit it may block a second request from any other terminal 5b, 5c which occurs before expiry of the timer set when the first terminal 5a sent its information request. Otherwise, control of each terminal making a request is not influenced by other terminals making their requests.

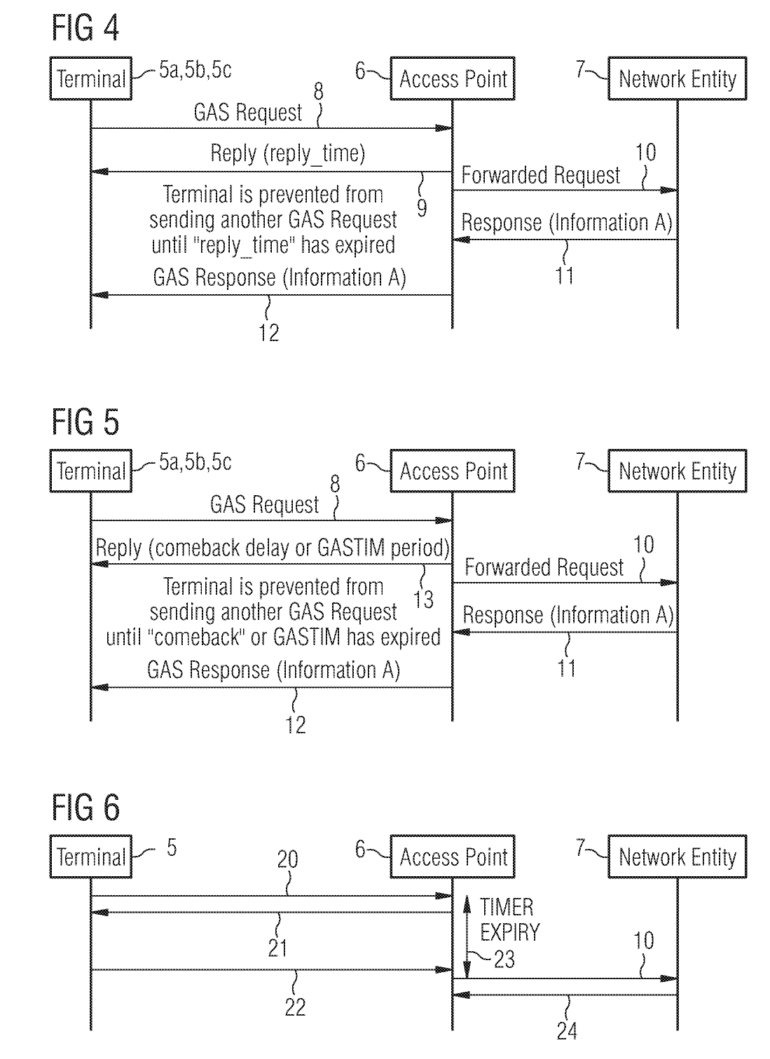

In the message exchange shown in FIG. 5, when the AP 6 receives a GAS request 8 from a user device, or terminal 5b (identified by its unique MAC address) the AP immediately replies with a comeback delay, or a GASTIM Period indication 13 and forwards 10 the request to the network entity 7, if required. The comeback delay represents the time after which the GAS response 12 will be sent from the AP to the terminal. The GASTIM Period information indicates the number of IEEE 802.11 beacon intervals after which the GAS response is sent from the AP to the terminal. If the terminal tries to send a new GAS request before the comeback delay, or the GASTIM Period, have expired, the AP ignores it and block requests from the terminal for a fixed interval of time. The GAS response may be generated in the AP, or from the response 11 from the network entity 7. The comeback delay and GASTIM Period are set depending on the rate at which GAS requests are received by the AP, i.e. if the AP receives a high rate of GAS requests, the comeback delay or GASTIM Period will be set to higher values. Usually these parameters are only set depending on the time needed for the AP to get hold of the data, either from the network, or locally, needed to formulate and send the response back.

The method is able to control the rate at which information requests are sent in a system that has no checks or other constraints on the use of the network access point by the terminal or home node B before it transmits. An IEEE 802.11u capable AP using this method is able to control the rate at which GAS requests are processed and GAS response are sent back to the IEEE 802.11u terminal. The method addresses the problem of terminals causing usage of radio and core network resources for sending, or receiving GAS requests, or responses in an unauthorized and un-associated state, so saving power within the AP and radio resources within the IEEE 802.11 network.

However, this first aspect does not deal with terminals which are malicious or operated in an abusive fashion. The method assumes that the terminals are giving a valid identifier, such as a MAC address as their sole identifier, whereas a terminal could in fact keep changing its MAC address to submit additional requests. If this is done, the system is protected only by increasing the timer window, so that it does not have to respond to the requests as quickly.

Thus, another aspect addresses the problem of rogue user devices changing, or forging, their identifier, so that for any identity based control, the access point and the network are overwhelmed by the number of requests, or transmission that they have to deal with. When a user device sends a first information request to an access point, the access point obtains identity data, for example a MAC address of the terminal, along with some information which assists in the control of resource utilization. This could be a time of receipt of the first request, a sequence number of that requires or some other utilization indicator. The user device identifier and the utilization indicator are encrypted and packaged and sent back to the requesting user device.

When a second information request is received from the user device, it includes the encrypted package, so that the access point can decrypt the data and compare the data with current data to determine whether the request should be processed. For example, if the utilization indicator is a timer, the comparison is whether the time period set has been exceeded yet and the user device identifier is checked against a current identifier in the second request. If the terminal is a rogue terminal which has changed its address or identity since the first information request, then the AP can reject the request. This may be done with, or without, notification to the user device that its request has been dropped. This aspect uses more power and has increased costs as compared to the first aspect.

For the example of 802.11 GAS requests, shown in FIG. 6, whenever an AP 6 receives an IEEE 802.11u GAS request 20 from a terminal, the AP generates a package, for example a cookie, with the encrypted terminal media access control (MAC) address and utilization indicator, such as the cookie creation time, or time of receipt of the request. The AP will reply 21 to the terminal with the cookie and with a time (Td) after which the terminal has to contact the AP again, e.g. with a come back delay. Td has a random distribution. The terminal cannot see the content of the encrypted cookie. Separately, the access point provides a time delay, visible to the station, as well as in the cookie, indicating that if the terminal really does wish to have resources allocated, it must ask again after that time delay has expired. The access point then deletes everything about the GAS request. The terminal stores the cookie and status of the request and then sends back 22 the cookie as a reminder to the access point, after expiry 23 of the timer.

When the terminal sends back 22 the cookie, it might include other information, such as a request or query identifier. The access point will decrypt the returned cookie and compare the MAC address stored in there with the MAC address which the terminal has at the time of the second request attempt and determine that if they are different, the terminal is a rogue terminal.

The access point can also read the time of receipt of the original request and the timer, then if the second request is made before expiry of the timer, the access point can decide how to treat it. For example, the second request may be dropped without notification, delayed for processing at a later time, or dropped with a notification to the terminal. If the MAC address and the timer conditions are both satisfied, the access point responds accordingly to the terminal's request. The response may be generated in the AP or from a response 24 from the network entity 7, if required.

If the cookie arrives from a different MAC address from that encrypted in the cookie and the request is not considered, the terminal may be blocked from having any further requests processed.

The benefit of this process is that it enforces employment of restricted resources for GAS request/response by virtue of the Td timer. The processing load is passed back to the terminal, which has to store the cookie and status of the request, then send back the cookie as a reminder to the access point at the appropriate time. If a terminal is a rogue, it ends up having to do much more work to prevent being caught. If a rogue terminal is detected, the access point may block the terminal, or notify the core network that the terminal is a rogue, so that it is blocked throughout the network.

This method does not require the AP to keep track of terminal's MAC addresses and timers. Overall, there is a higher implementation effort and increase in system complexity, compared to a conventional system which takes no steps to counter rogue terminals.

The method allows for flow control using a timer and makes it harder for a rogue terminal to use unauthorized, unauthenticated resources. The method requires slightly more complexity in the access point because of the need for cookie generation and encryption and some increase in power use and hence cost at the terminal because it has to store status information.

The example has been described with respect to 802.11, but can be applied to any system where a user device is not constrained in its communication with an access point in a wireless network, so for example, transmissions from a home base station in a mobile communication system, such as the UMTS network of FIG. 1 can be controlled by the network access point setting a delay and an identity check in a similar way to that described with respect to the 802.11 example.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-33. (canceled)

34. A method of controlling information requests in a system operating in an unauthorized, un-associated mode, the system comprising at least one user device and an access point; the method comprising:
receiving at the access point a first information request from a user device;
setting a utilization indicator;
receiving at the access point a second information request;
checking whether the utilization identifier has expired; and
processing a response to the second information request only if the utilization identifier has not expired.

35. A method according to claim 34, wherein
the first information request is sent by a first user device together with a first user device identifier that identifies the first user device,
the second information request is sent by a second user device together with a second user device identifier that identifies the second user device,
the first and second user devices are the same or different user devices, and
checking whether the utilization indicator has expired is independent of an identity of the second user device, as indicated by the second user device identifier.

36. A method according to claim 34, wherein
the first information request is sent by a first user device together with a first user device identifier that identifies the first user device,
the second information request is sent by a second user device together with a second user device identifier that identifies the second user device,
the first and second user devices are the same or different user devices, and
checking whether the utilization indicator has expired is only performed if the second user device identifier is the same as the first user device identifier.

37. A method according to claim 34, wherein the access point varies how long the utilization indicator is valid to reduce the number of requests to which responses are provided.

38. A method according to claim 34, wherein
Information requests are processed by the access point and a core server, and
the utilization indicator is set according to the number of information requests which can be processed by the access point and the core server.

39. A method according to claim 34, wherein the utilization indicator is sent to the first user device making the first information request.

40. A method according to claim 34, wherein the system is a wireless access network.

41. A method according to claim 34, wherein the system is one of a wireless local area network and a home base station network.

42. A method according to claim 34, wherein
the utilization indicator comprises a timer, and
the timer is set according to one of a generic advertisement server traffic indication map period and a generic advertisement server comeback delay.

43. A method of controlling information requests in a communication system operating in an unauthenticated, un-associated state, the system comprising a user device and an access point, the method comprising:
sending a first information request from the user device to the access point;
at the access point, determining data including a user device identifier that identifies the user device and a utilization indicator;
encrypting the data and returning encrypted data to the user device;
receiving a second information request from the user device, including the encrypted data and a current user device identifier;
decrypting the encrypted data to produce a decrypted user device identifier and a decrypted utilization indicator;
comparing, in a first comparison, the decrypted user device identifier with the current user device identifier; and
comparing, in a second comparison, the decrypted utilization indicator with a current utilization indicator; and
responding to the second information request only if the first comparison and/or the second comparison shows a match.

44. A method according to claim 43, wherein only if both the first and second comparisons show a match, is a response sent to the second information request.

45. A method according to claim 43, wherein if neither comparisons shows a match, the access point drops the second information request.

46. A method according to claim 45, wherein a notification is sent to the user device if the second information request has been dropped.

47. A method according to claim 43, wherein the encrypted data is packaged for sending to the user device.

48. A method according to claim 47, wherein the package is a cookie.

49. A method according to claim 43, wherein the utilization indicator comprises a base time or a base sequence number.

50. A method according to claim 43, wherein
the utilization identifier identifies a base time, and
the second comparison comprises determining an elapsed time between the base time identified by the decrypted utilization indicator and the base time identified by the current utilization indicator.

51. A method according to claim 43, wherein
the utilization indicator comprises a base sequence number, and
the second comparison considers an amount by which the base sequence number has changed.

52. A method according to claim 49, wherein an unencrypted timer is returned to the user device with the encrypted data.

53. A method according to claim 50, wherein
the second comparison considers whether the elapsed time is greater than a time set in a timer, and
the first comparison considers whether the decrypted user device identifier is the same as the current user device identifier.

54. A method according to claim 43, wherein
the utilization identifier identifies a base sequence number, and
the second comparison comprises determining whether the base sequence number identified by the current utilization identifier is greater than the base sequence number identified by the decrypted utilization identifier by at least a predetermined amount

55. A method according to claim 43, wherein, a notification is sent to a core network if the decrypted user device identifier is not the same as the current user device identifier.

56. A method according to claim 49, wherein
the utilization identifier comprises the base time, and
the base time is a time of receipt of the first information request at the access point.

57. A method according to claim 49, wherein
the utilization identifier comprises the base time, and
the base time is a starting point for an elapsed time to be calculated from.

58. A method according to claim 43, wherein, the access point is a wireless access point.

59. A method according to claim 58, wherein the wireless access point is one of a wireless local area network and a home base station.

60. A method according to claim 43, wherein the first and second information requests are a generic advertisement protocol request.

61. A method according to claim 43, wherein the user device identifier is a media access control address.

62. A method according to claim 43, wherein the utilization indicator is varied in accordance with a level of congestion in the system.

63. A communication system operating in an unauthenticated, un-associated state, comprising:
a user device; and
an access point, comprising:
an encryption device to encrypt data received from the user device in a first information request, to thereby produce encrypted data;
a transmitter to transmit the encrypted data to the user device; and
a processor to compare data received from the user device in a second information request with the data encrypted,
and wherein the user device comprises a memory to store the encrypted data received from the access point, for resending with a second information request.

64. A system according to claim 63, wherein the access point varies a utilization indicator to control a rate at which further information requests are received and acted upon.

65. A system according to claim 63, wherein
the data comprises a base time for the first information request,
the access point further comprises a timer, and
the processor determines whether an elapsed time from the base time is greater than a length of time set by the timer.

66. A system according to claim 63, wherein the user device is one of a wireless local area network terminal and a home base station.
